(19) United States
(12) Patent Application Publication
(10) Pub. No.: US 2025/0004225 A1
(43) Pub. Date: Jan. 2, 2025

(54) TECHNOLOGIES FOR SUBSTRATE FEATURES FOR A PLUGGABLE OPTICAL CONNECTOR

(71) Applicant: Intel Corporation, Santa Clara, CA (US)

(72) Inventors: Mohanraj Prabhugoud, Beaverton, OR (US); David Shia, Portland, OR (US); Tarek A. Ibrahim, Mesa, AZ (US); Yuxin Fang, Chandler, AZ (US)

(73) Assignee: Intel Corporation, Santa Clara, CA (US)

(21) Appl. No.: 18/345,106

(22) Filed: Jun. 30, 2023

(51) Int. Cl. G02B 6/42

(52) U.S. Cl. CPC G02B 6/4292; G02B 6/4234

(57) ABSTRACT

Technologies for substrate features for a pluggable optical connectors in an integrated circuit package are disclosed. In the illustrative embodiment, a substrate includes a cavity cut through a substrate of the integrated circuit package. Sidewalls of the cavity establish coarse lateral alignment features for an optical plug. The optical plug and optical socket include additional alignment features to more precisely align optical fibers in the optical plug to an optical interposer mounted on the substrate. The cavity cut through the substrate may also include indents that can mate with protrusions of the optical plug to retain the optical plug. The optical interposer may be mounted on a recessed shelf in the substrate.

### BACKGROUND

Photonic integrated circuits (PICs) can be used for several applications, such as communications. Efficiently and cheaply aligning optics to couple light into and out of PICs can be a challenge. Approaches such as attachment of optical fiber arrays to PICS may be slow, incompatible with conventional semiconductor packaging processes, and can result in substantial yield and throughput issues.

### BRIEF DESCRIPTION OF THE DRAWINGS

FIG. 1 is a simplified drawing of one embodiment of a system with an optical socket on an integrated circuit package.

FIG. 2 is a simplified drawing of one embodiment of a connectorized optical cable with an optical plug that can mate with the optical socket of FIG. 1.

FIG. 3 is a simplified drawing of one embodiment of the connectorized optical cable of FIG. 2 that has been disassembled.

FIG. 4 is a simplified drawing of the integrated circuit package of FIG. 1 with a lid and an optical plug.

FIG. 5 is a simplified flow diagram of at least one embodiment of a method for manufacturing a system including a connectorized optical cable with an optical plug and an integrated circuit package.

FIG. 6 is a top view of a wafer and dies that may be included in a microelectronic assembly, in accordance with any of the embodiments disclosed herein.

FIG. 7 is a cross-sectional side view of an integrated circuit device that may be included in a microelectronic assembly, in accordance with any of the embodiments disclosed herein.

FIGS. 8A-8D are perspective views of example planar, gate-all-around, and stacked gate-all-around transistors.

FIG. 9 is a cross-sectional side view of an integrated circuit device assembly that may include a microelectronic assembly, in accordance with any of the embodiments disclosed herein.

FIG. 10 is a block diagram of an example electrical device that may include a microelectronic assembly, in accordance with any of the embodiments disclosed herein.

### DETAILED DESCRIPTION

In various embodiments disclosed herein, a connectorized optical cable with an optical plug can plug into an optical socket of an integrated circuit package. The optical plug includes a ferrule with alignment features that allow it to be precisely aligned with fibers or waveguides in an optical socket (e.g., with sub-micron precision). In order for the plug to be coarsely aligned with an optical socket, in the illustrative embodiment, a substrate of the optical socket has a cavity cut out from it, with the sidewalls of the cavity defining a coarse lateral positioning for the optical plug. An optical interposer that mates with the optical plug may be positioned on a recessed shelf of the substrate. As described in more detail below, the cavity in the substrate can reduce the parts required for the optical socket or simplify processing compared to alternative approaches.

As used herein, the phrase “communicatively coupled” refers to the ability of a component to send a signal to or receive a signal from another component. The signal can be any type of signal, such as an input signal, an output signal, or a power signal. A component can send or receive a signal to another component to which it is communicatively coupled via a wired or wireless communication medium (e.g., conductive traces, conductive contacts, air). Examples of components that are communicatively coupled include integrated circuit dies located in the same package that communicates via an embedded bridge in a package substrate and an integrated circuit package attached to a printed circuit board that send signals to or receives signals from other integrated circuit packages or electronic devices attached to the printed circuit board.

In the following description, specific details are set forth, but embodiments of the technologies described herein may be practiced without these specific details. Well-known circuits, structures, and techniques have not been shown in detail to avoid obscuring an understanding of this description. Phrases such as “an embodiment,” “various embodiments,” “some embodiments,” and the like may include features, structures, or characteristics, but not every embodiment necessarily includes the particular features, structures, or characteristics.

Some embodiments may have some, all, or none of the features described for other embodiments. “First,” “second,” “third,” and the like describe a common object and indicate different instances of like objects being referred to. Such adjectives do not imply objects so described must be in a given sequence, either temporally or spatially, in ranking, or any other manner. “Connected” may indicate elements are in direct physical or electrical contact, and “coupled” may indicate elements co-operate or interact, but they may or may not be in direct physical or electrical contact. Furthermore, the terms “comprising,” “including,” “having,” and the like, as used with respect to embodiments of the present disclosure, are synonymous. Terms modified by the word “substantially” include arrangements, orientations, spacings, or positions that vary slightly from the meaning of the unmodified term. For example, the central axis of a magnetic plug that is substantially coaxially aligned with a through hole may be misaligned from a central axis of the through hole by several degrees. In another example, a substrate assembly feature, such as a through width, that is described as having substantially a listed dimension can vary within a few percent of the listed dimension.

It will be understood that in the examples shown and described further below, the figures may not be drawn to scale and may not include all possible layers and/or circuit components. In addition, it will be understood that although certain figures illustrate transistor designs with source/drain regions, electrodes, etc. having orthogonal (e.g., perpendicular) boundaries, embodiments herein may implement such boundaries in a substantially orthogonal manner (e.g., within +/−5 or 10 degrees of orthogonality) due to fabrication methods used to create such devices or for other reasons.

Reference is now made to the drawings, which are not necessarily drawn to scale, wherein similar or same numbers may be used to designate the same or similar parts in different figures. The use of similar or same numbers in different figures does not mean all figures including similar or same numbers constitute a single or same embodiment. Like numerals having different letter suffixes may represent different instances of similar components. The drawings illustrate generally, by way of example, but not by way of limitation, various embodiments discussed in the present document.

In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives within the scope of the claims.

As used herein, the phrase “located on” in the context of a first layer or component located on a second layer or component refers to the first layer or component being directly physically attached to the second part or component (no layers or components between the first and second layers or components) or physically attached to the second layer or component with one or more intervening layers or components.

As used herein, the term “adjacent” refers to layers or components that are in physical contact with each other. That is, there is no layer or component between the stated adjacent layers or components. For example, a layer X that is adjacent to a layer Y refers to a layer that is in physical contact with layer Y.

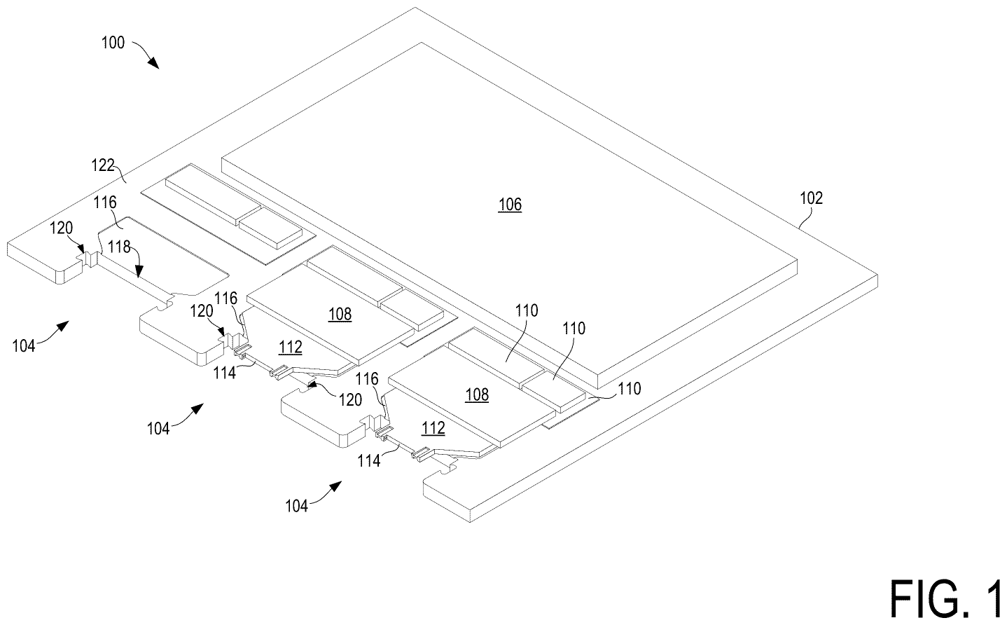

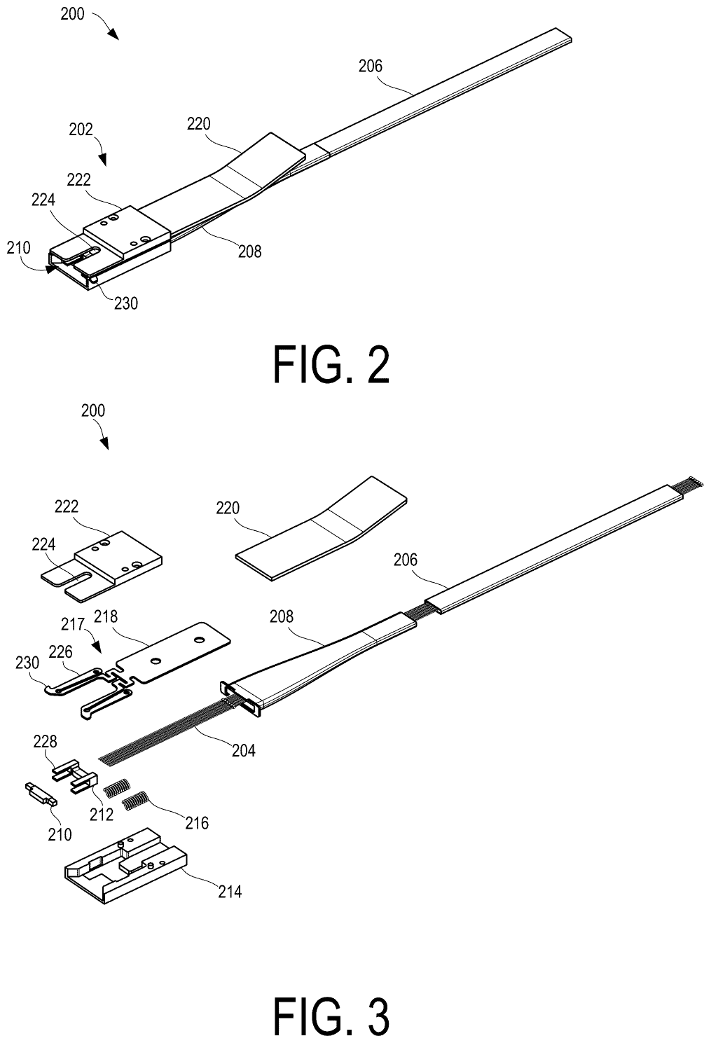

Referring now to FIG. 1, in one embodiment, an integrated circuit package 100 includes a substrate 102, one or more optical sockets 104, and an electrical integrated circuit (EIC) die 106. In the illustrative embodiment, the optical sockets 104 are formed from the substrate 102 and an optical coupler interposer 112. The interposer 112 has a face 114 in which the ends of one or more waveguides are positioned. When the optical plug 202 (see FIG. 2) is mated with the optical socket 104, the optical fibers 204 of the optical plug 202 are lined up with the waveguides in the interposer 112 to within, e.g., less than one micrometer.

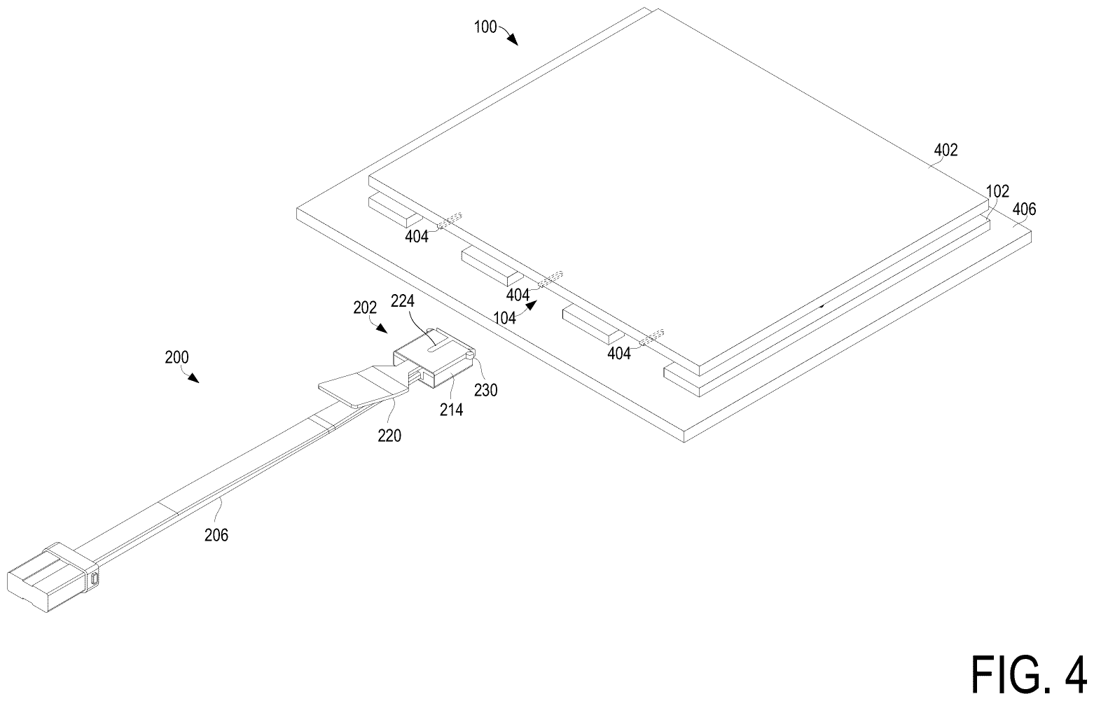

In the illustrative embodiment, the optical socket 104 is at least partially defined by a cavity 118 defined in the substrate 102. The illustrative cavity 118 is cut all the way through the substrate 102. The sidewalls of the cavity 118 define coarse lateral alignment features for the optical plug 202. The optical plug 202 can be coarsely aligned vertically by a lid 402 and another substrate 406, as described below in more detail in regard to FIG. 4.

The cavity 118 may include indents 120 that act as latching features. The indents 120 extend from the sidewalls of the cavity 118 further inward into the substrate 102. Protrusions 230 of the optical plug 202 can lock into position in the indents 120, preventing the optical plug 202 from being removed.

In the illustrative embodiments, the interposer 112 is positioned on a shelf 116 that is slightly recessed from a top surface 122 of the substrate 102. The shelf 116 may position the interposer 112 at a desired height relative to other components, such as the substrate 102, the lid 402, the plug 202, etc. The shelf 116 may have any suitable depth, such as 0-250 micrometers.

In the illustrative embodiment, a photonic integrated circuit (PIC) die 108 is mated with the optical interposer 112. In the illustrative embodiment, waveguides in the interposer 112 can carry light between the optical fibers 204 of the optical plug 202 and the PIC dies 108.

The substrate 102 may support several additional integrated circuit dies 110, which may be PIC dies, EIC dies, or a combination of both. The additional integrated circuit dies 100 may facilitate communication, power delivery, and other suitable connections between the PIC dies 108 and the EIC die 106.

It should be appreciated that the cavity 118 and shelf 116 provide several benefits as compared to alternative approaches. For example, in one alternative approach, an additional component may be mated with the substrate 102 to form part of the optical socket 104, such as part of the optical socket 104 to provide coarse lateral alignment and/or features to retain the optical plug 202 by mating with the protrusions 230. By forming part of the optical socket 104 from the substrate 102 itself, such an additional component can be removed. In another alternative approach, the substrate 102 can extend partially from the top surface 122 but not extend all the way through the substrate 102 to a bottom surface. Such an approach can provide similar coarse alignment features as the cavity 118. However, extending the cavity 118 all the way through the substrate 102 can simplify processing steps to form the cavity 118, reducing the cost and improving yield. Additionally, the shelf 116 can both provide flexibility in vertical positioning of the optical interposer 112 and can be formed with relatively simple processing steps, as described below in more detail in regard to the method 500.

The illustrative substrate 102 may be any suitable substrate, such as glass, silicon, ceramic, a circuit board, etc. In some embodiments, the substrate 102 is a circuit board made from any suitable material, such as ceramic, glass, and/or organic-based materials with fiberglass and resin, such as FR-4. In some embodiments, the substrate 102 is formed from or otherwise includes bismaleimide-triazine (BT) resin. The substrate 102 may have any suitable length or width, such as 10-500 millimeters. The substrate 102 may have any suitable thickness, such as 0.2-5 millimeters. The substrate 102 may support additional components besides those shown in FIG. 1, such as resistors, capacitors, other integrated circuit dies, power electronics, traces, etc.

The illustrative interposer 112 is silicon oxide glass. In other embodiments, the interposer 112 may be made of any suitable material that may be crystalline, non-crystalline, amorphous, etc., such as fused silicon, borosilicate, sapphire, yttrium aluminum garnet, etc. The interposer 112 may be, e.g., aluminosilicate glass, borosilicate glass, alumino-borosilicate glass, silica, fused silica. The interposer 112 may include one or more additives, such as Al2O3, B2O3, MgO, CaO, SrO, BaO, SnO2, Na2O, K2O, SrO, P2O3, ZrO2, Li2O, Ti, and Zn. The glass interposer 112 may comprise silicon and oxygen, as well as any one or more of aluminum, boron, magnesium, calcium, barium, tin, sodium, potassium, strontium, phosphorus, zirconium, lithium, titanium, and zinc. The interposer 112 may include at least 20-40 percent silicon by weight, at least 20-40 percent oxygen by weight, and at least 5 percent aluminum by weight. For example, some embodiments of the interposer 112 may include, e.g., at least 20-23 percent silicon and at least 20-26 percent oxygen by weight. The interposer 112 may have any suitable length or width, such as 10-500 millimeters. The interposer 112 may have any suitable thickness, such as 0.2-5 millimeters.

The interposer 112 may route light between the optical plug 202 and the PIC dies 108 using waveguides defined in the interposer 112. The waveguides may be routed in any suitable manner, including in three dimensions, allowing for flexible layouts. The interposer 112 may include optical elements such as fan outs, splitters, couplers, combiners, filters, etc. The integrated circuit package 100 may include any suitable number of interposers 112 and optical sockets 104, such as 1-64 or more.

The PIC die 108 may be made of any suitable material, such as silicon. In the illustrative embodiment, waveguides are defined in the PIC die 108 that interface with waveguides defined in the interposer 112 to transfer light to or from the PIC die 108. In an illustrative embodiment, waveguides in the PIC die 108 may be silicon waveguides embedded in silicon oxide cladding. The PIC dies 108 may include any suitable number of waveguides, such as 1-1,024.

The PIC die 108 is configured to generate, detect, and/or manipulate light. The PIC die 108 may include active or passive optical elements such as splitters, couplers, filters, optical amplifiers, lasers, photodetectors, modulators, etc. The PIC die 108 may have electrical connections to the substrate 102 and/or the EIC die 106, such as for power delivery, sending and receiving data, and/or the like.

The EIC die 106 may include any suitable electronic integrated circuit package, such as resistors, capacitors, inductors, transistors, etc. The EIC die 106 may include any suitable analog and/or digital circuitry, such as a processor, a memory, an application-specific integrated circuit (ASIC), a field-programmable gate array (FPGA), etc. In some embodiments, the integrated circuit package 100 may be embodied as a router, a switch, a network interface controller, and/or the like. In such embodiments, the EIC die 106 may include network interface controller circuitry to process, parse, route, etc., network packets sent and received by the integrated circuit package 100 through the optical cable 200.

Referring now to FIGS. 2 and 3, in one embodiment, an optical cable 200 includes one or more optical fibers 204 in a sheath 206 connected to an optical plug 202. FIG. 2 shows an assembled optical cable 200, and FIG. 3 shows a disassembled optical cable 200, showing several of the parts of the optical cable. A strain relief 208 is positioned between the sheath 206 and the optical plug 202. In the illustrative embodiment, the optical fibers 204 are free to move inside the strain relief 208, providing some slack in the optical fibers 204 and allowing the ferrule 210 to move relative to the strain relief 208. When assembled, the optical fibers 204 extend through the ferrule 210, terminating at an end face of the ferrule 210. A ferrule holder 212 holds the ferrule 210 loosely in place. Housing 214 holds the ferrule 210 and the ferrule holder 212. A housing cover 222 keeps the ferrule 210 and ferrule holder 212 within the housing 214. In the illustrative embodiment, springs 216 apply a force on the ferrule holder 212 and the ferrule 210. In use, as the plug 202 is mated with an optical socket 104, the springs 216 apply a force on the ferrule 210, pressing it against the optical socket, ensuring the ferrule 210 is in contact with the optical socket.

Retention mechanism 217 is also positioned inside of the housing 214. As the plug 202 is plugged into a socket, protrusions 230 of a spring clip 226 engage with the indents 120 of the socket 104, securing the optical plug 202 in place. Pulling on tab 218 of the retention mechanism 217 will pull the protrusions 230 of the spring clip 226 inward, freeing the plug 202 from the socket. Tab cover 220 can be attached to the tab 218 to allow a user to pull on the retention mechanism 217 more easily. In some embodiments, the retention mechanism 217 may press the ferrule 210 against the optical socket instead of or in addition to the springs 216.

The housing cover 222 includes a slot 224, which can be used to both coarsely align the plug 202 as well as act as an orientation key, preventing the optical plug 202 from being inserted upside down. The slot 224 may interface with the rib 404 shown in FIG. 4. In addition to or as an alternative to the housing cover, in some embodiments, the optical plug 202 may include a sleeve surrounding the housing 214. The sleeve may contain the components of the optical plug 202 while allowing for servicing by removal of the sleeve.

It should be appreciated that the ferrule holder 212 and the ferrule 210 can move within the housing 214 and that the ferrule 210 can move within the ferrule holder 212. As such, as the plug 202 is inserted into a socket, the ferrule holder 212 can move relative to the housing 214 to more precisely align the ferrule holder 212, and then the ferrule 210 can move relative to the ferrule holder 212 to more precisely align the ferrule 210. The ferrule holder 212 may be aligned using alignment features 228. The housing 214, the ferrule holder 212, and the ferrule 210 provide multi-stage alignment.

The optical cable 200 may include any suitable number of optical fibers, such as 1-32 fibers. The optical fibers 204 may be arranged at the ferrule 210 in a one- or two-dimensional array. The illustrative optical fibers 204 are made out of glass and can carry light at any suitable wavelength, such as 400-2,000 nanometers. In the illustrative embodiment, the optical fibers 204 may support light in the C-band, O-band, L-band, S-band, etc. In other embodiments, the optical fibers 204 may be made out of a different material.

The ferrule 210 may be made of any suitable material, such as glass or ceramic. In some embodiments, the ferrule 210 may be formed using laser machining. The ferrule 210 may include one or more alignment features that align the ferrule 210 precisely with an optical socket. For example, the alignment features on the ferrule 210 may align the ferrule 210 to within less than one micrometer. The optical cable 200 may have an optical plug on the opposite end, which may be similar to, the same as, or different from the optical plug 202.

The optical plug 202 may have any suitable dimensions. In the illustrative embodiment, the optical plug 202 has a width of about 5 millimeters and a height of about 1.5 millimeters. In other embodiments, the optical plug 202 may have a height and/or width of, e.g., 1-10 millimeters.

Referring now to FIG. 4, in one embodiment, the integrated circuit component 100 may be mounted on another component, such as a substrate 406. The substrate 406 may be, e.g., a motherboard, another circuit board connecting the integrated circuit package 100 with other components, a housing, etc. The substrate 406 may be a similar or the same material as the substrate 102.

As shown in FIG. 4, in use, the integrated circuit package 100 may include a lid 402. The lid 402 may provide coarse alignment for the plug 202. The lid 402 may have a rib 404 that forms part of the socket 104. The rib 404 may align with a slot 224 defined in the optical plug 202. The rib 404 and slot 224 may establish a keying that prevents the optical plug 202 from being inserted upside down.

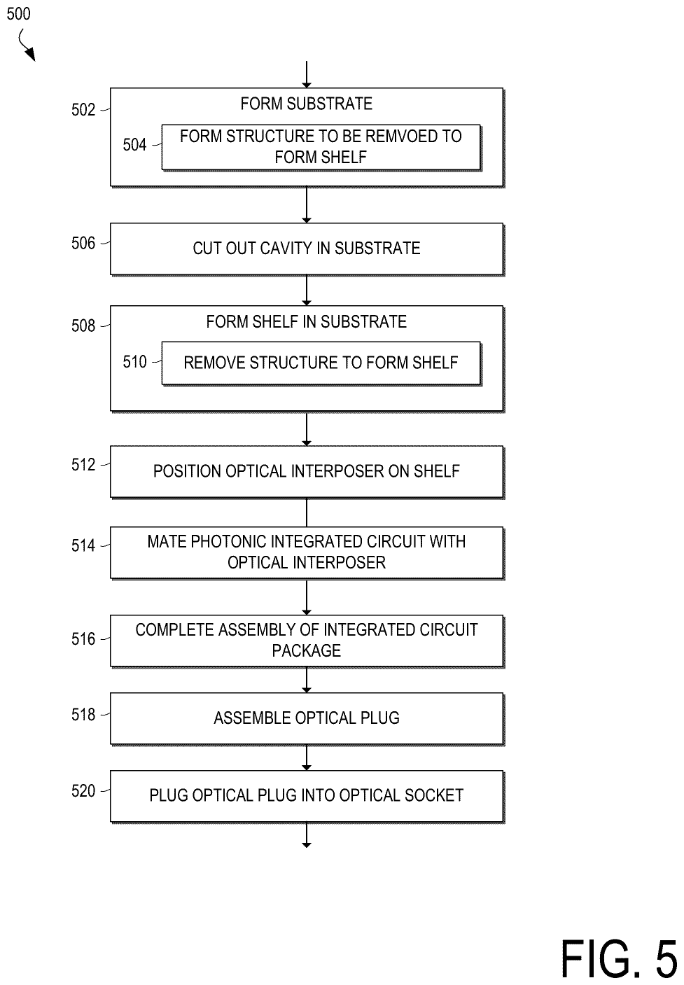

Referring now to FIG. 5, in one embodiment, a flowchart for a method 500 for creating an integrated circuit package with an optical socket is shown. The method 500 may be executed by a technician and/or by one or more automated machines. In some embodiments, one or more machines may be programmed to do some or all of the steps of the method 500. Such a machine may include, e.g., a memory, a processor, data storage, etc. The memory and/or data storage may store instructions that, when executed by the machine, causes the machine to perform some or all of the steps of the method 500. The method 500 may use any suitable set of techniques that are used in semiconductor processing, such as chemical vapor deposition, atomic layer deposition, physical layer deposition, molecular beam epitaxy, layer transfer, photolithography, ion implantation, dry etching, wet etching, selective laser etching, thermal treatments, flip chip, layer transfer, magnetron sputter deposition, pulsed laser deposition, laser machining, etc. It should be appreciated that the method 500 is merely one embodiment of a method to create one embodiment of a system and other methods may be used to create any suitable embodiment of the system. In some embodiments, steps of the method 500 may be performed in a different order than that shown in the flowchart.

The method 500 begins in block 502, in which a substrate 102 is formed. In an illustrative embodiment, structure is formed in the substrate 102 that will be removed in order to form the shelf 116. For example, in one embodiment, one or more layers of copper or other sacrificial material may be deposited over the area where the shelf 116 will be defined, with structure such as a tab attached to them, allowing them to be removed at a later time.

In block 506, the cavity 118 is cut out of the substrate, including the indents 120 to mate with the protrusions 230 of the optical plug 202. The cavity 118 may be cut out in any suitable manner, such as mechanical cutting or grinding, chemical etching, and/or a combination thereof.

In block 508, the shelf 116 for the interposer 112 is formed in the substrate 102. In an illustrative embodiment, the shelf 116 is formed by removing structure positioned over the shelf 116. For example, a tab connected to the structure may be pulled, physically ripping out the structure, forming the shelf 116 in the substrate 102. In block 512, the optical interposer 112 is positioned in the shelf 116.

In block 514, a PIC die 108 is mated with the optical interposer 112. The PIC die 108 may be positioned using pick and place. The PIC die 108 may be aligned using any suitable alignment features, such as physical structure or fiducials on the interposer 112 and/or the PIC die 108. The PIC die 108 may be secured in place relative to the optical interposer 112 using, e.g., epoxy.

In block 516, the assembly of the integrated circuit package 100 is completed, such as patterning traces, placing additional integrated circuit dies 106, 110, placing additional components such as resistors, capacitors, etc. In some embodiments, some or all of the other assembly steps may be performed before the optical interposer 112 and/or PIC die 108 are integrated into the integrated circuit package 100.

In block 518, the optical cable 200 is assembled. The optical cable 200 includes an optical plug 202 that may include the optical ferrule, a ferrule holder, one or more springs to press the ferrule against the interposer, a retention mechanism with a spring clip and pull tab, etc.

In block 520, the optical plug 202 is plugged into the optical socket 104, optically coupling the one or more optical fibers in the plug to the one or more waveguides in the interposer 112. It should be appreciated that the optical plug 202 can be freely inserted or removed after assembly of the integrated circuit package 100.

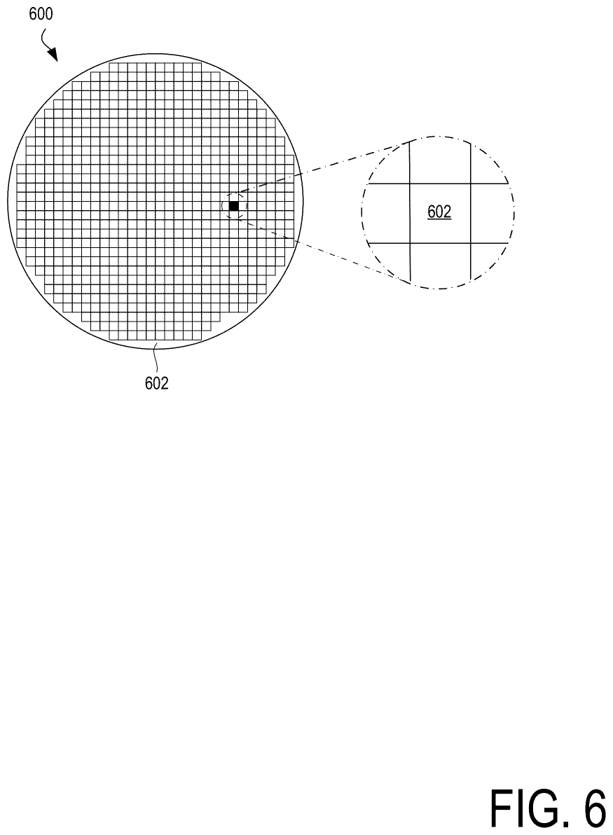

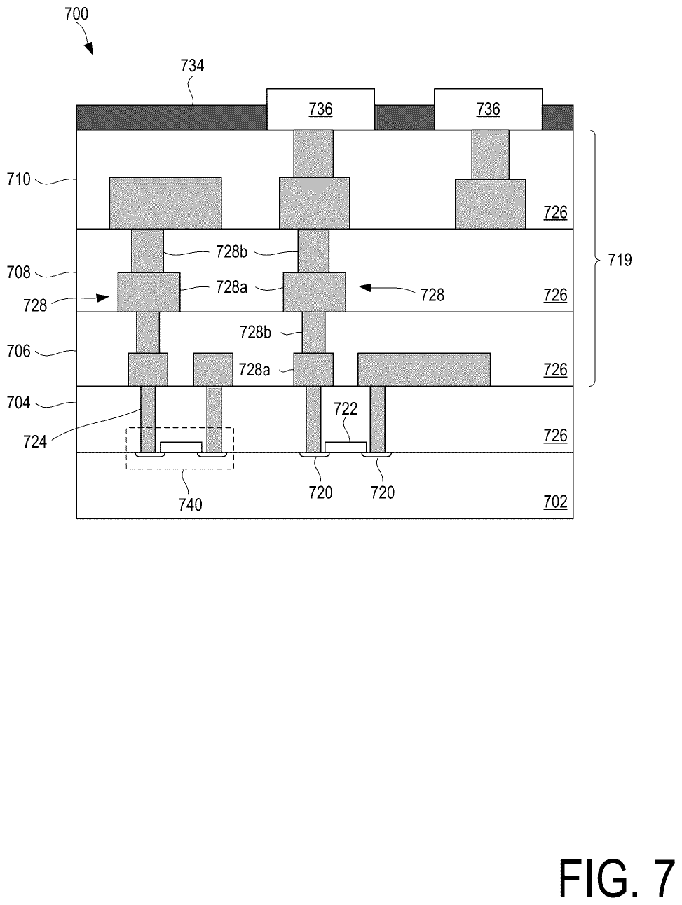

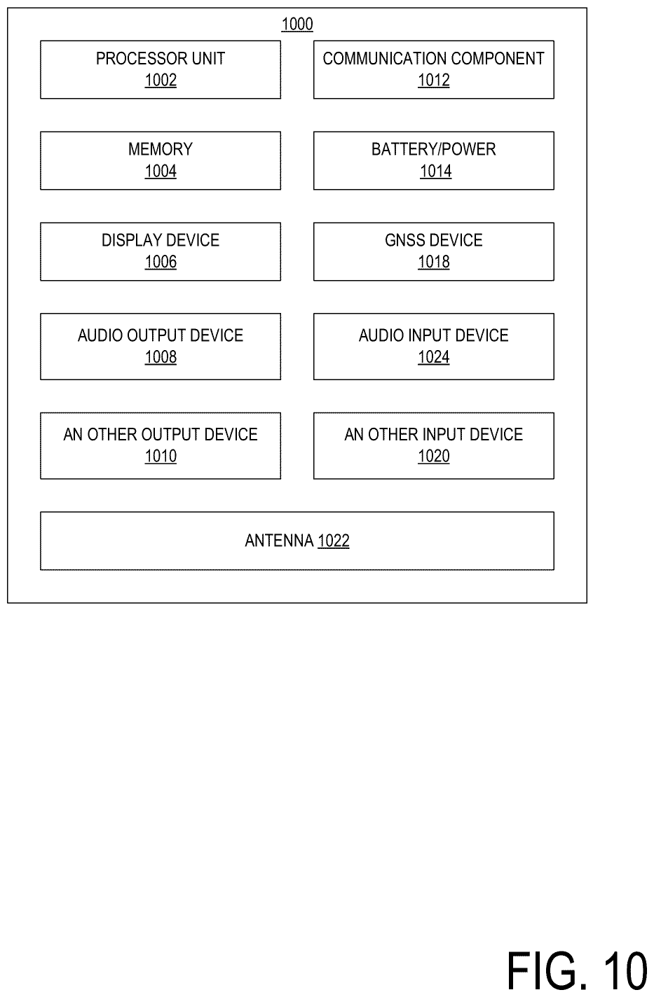

FIG. 6 is a top view of a wafer 600 and dies 602 that may be included in any of the integrated circuit packages 100 disclosed herein (e.g., as any suitable ones of the dies 106, 108, 110). The wafer 600 may be composed of semiconductor material and may include one or more dies 602 having integrated circuit structures formed on a surface of the wafer 600. The individual dies 602 may be a repeating unit of an integrated circuit product that includes any suitable integrated circuit. After the fabrication of the semiconductor product is complete, the wafer 600 may undergo a singulation process in which the dies 602 are separated from one another to provide discrete “chips” of the integrated circuit product. The die 602 may be any of the dies 106, 108, 110 disclosed herein. The die 602 may include one or more transistors (e.g., some of the transistors 740 of FIG. 7, discussed below), supporting circuitry to route electrical signals to the transistors, passive components (e.g., signal traces, resistors, capacitors, or inductors), and/or any other integrated circuit components. In some embodiments, the wafer 600 or the die 602 may include a memory device (e.g., a random access memory (RAM) device, such as a static RAM (SRAM) device, a magnetic RAM (MRAM) device, a resistive RAM (RRAM) device, a conductive-bridging RAM (CBRAM) device, etc.), a logic device (e.g., an AND, OR, NAND, or NOR gate), or any other suitable circuit element. Multiple ones of these devices may be combined on a single die 602. For example, a memory array formed by multiple memory devices may be formed on a same die 602 as a processor unit (e.g., the processor unit 1002 of FIG. 10) or other logic that is configured to store information in the memory devices or execute instructions stored in the memory array. Various ones of the integrated circuit packages 100 disclosed herein may be manufactured using a die-to-wafer assembly technique in which some dies 106, 108, 110 are attached to a wafer 600 that include others of the dies 106, 108, 110, and the wafer 600 is subsequently singulated.

FIG. 7 is a cross-sectional side view of an integrated circuit device 700 that may be included in any of the integrated circuit packages 100 disclosed herein (e.g., in any of the dies 106, 108, 110). One or more of the integrated circuit devices 700 may be included in one or more dies 602 (FIG. 6). The integrated circuit device 700 may be formed on a die substrate 702 (e.g., the wafer 600 of FIG. 6) and may be included in a die (e.g., the die 602 of FIG. 6). The die substrate 702 may be a semiconductor substrate composed of semiconductor material systems including, for example, n-type or p-type materials systems (or a combination of both). The die substrate 702 may include, for example, a crystalline substrate formed using a bulk silicon or a silicon-on-insulator (SOI) substructure. In some embodiments, the die substrate 702 may be formed using alternative materials, which may or may not be combined with silicon, that include, but are not limited to, germanium, indium antimonide, lead telluride, indium arsenide, indium phosphide, gallium arsenide, or gallium antimonide. Further materials classified as group II-VI, III-V, or IV may also be used to form the die substrate 702. Although a few examples of materials from which the die substrate 702 may be formed are described here, any material that may serve as a foundation for an integrated circuit device 700 may be used. The die substrate 702 may be part of a singulated die (e.g., the dies 602 of FIG. 6) or a wafer (e.g., the wafer 600 of FIG. 6).

The integrated circuit device 700 may include one or more device layers 704 disposed on the die substrate 702. The device layer 704 may include features of one or more transistors 740 (e.g., metal oxide semiconductor field-effect transistors (MOSFETs)) formed on the die substrate 702. The transistors 740 may include, for example, one or more source and/or drain (S/D) regions 720, a gate 722 to control current flow between the S/D regions 720, and one or more S/D contacts 724 to route electrical signals to/from the S/D regions 720. The transistors 740 may include additional features not depicted for the sake of clarity, such as device isolation regions, gate contacts, and the like. The transistors 740 are not limited to the type and configuration depicted in FIG. 7 and may include a wide variety of other types and configurations such as, for example, planar transistors, non-planar transistors, or a combination of both. Non-planar transistors may include FinFET transistors, such as double-gate transistors or tri-gate transistors, and wrap-around or all-around gate transistors, such as nanoribbon, nanosheet, or nanowire transistors.

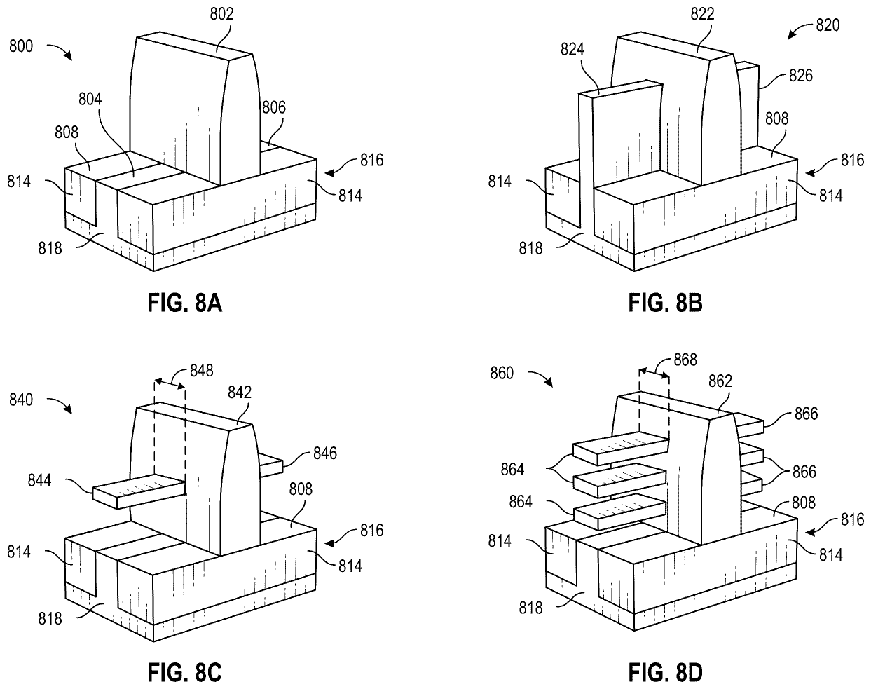

FIGS. 8A-8D are simplified perspective views of example planar, FinFET, gate-all-around, and stacked gate-all-around transistors. The transistors illustrated in FIGS. 8A-8D are formed on a substrate 816 having a surface 808. Isolation regions 814 separate the source and drain regions of the transistors from other transistors and from a bulk region 818 of the substrate 816.

FIG. 8A is a perspective view of an example planar transistor 800 comprising a gate 802 that controls current flow between a source region 804 and a drain region 806. The transistor 800 is planar in that the source region 804 and the drain region 806 are planar with respect to the substrate surface 808.

FIG. 8B is a perspective view of an example FinFET transistor 820 comprising a gate 822 that controls current flow between a source region 824 and a drain region 826. The transistor 820 is non-planar in that the source region 824 and the drain region 826 comprise “fins” that extend upwards from the substrate surface 828. As the gate 822 encompasses three sides of the semiconductor fin that extends from the source region 824 to the drain region 826, the transistor 820 can be considered a tri-gate transistor. FIG. 8B illustrates one S/D fin extending through the gate 822, but multiple S/D fins can extend through the gate of a FinFET transistor.

FIG. 8C is a perspective view of a gate-all-around (GAA) transistor 840 comprising a gate 842 that controls current flow between a source region 844 and a drain region 846. The transistor 840 is non-planar in that the source region 844 and the drain region 846 are elevated from the substrate surface 828.

FIG. 8D is a perspective view of a GAA transistor 860 comprising a gate 862 that controls current flow between multiple elevated source regions 864 and multiple elevated drain regions 866. The transistor 860 is a stacked GAA transistor as the gate controls the flow of current between multiple elevated S/D regions stacked on top of each other. The transistors 840 and 860 are considered gate-all-around transistors as the gates encompass all sides of the semiconductor portions that extends from the source regions to the drain regions. The transistors 840 and 860 can alternatively be referred to as nanowire, nanosheet, or nanoribbon transistors depending on the width (e.g., widths 848 and 868 of transistors 840 and 860, respectively) of the semiconductor portions extending through the gate.

Returning to FIG. 7, a transistor 740 may include a gate 722 formed of at least two layers, a gate dielectric and a gate electrode. The gate dielectric may include one layer or a stack of layers. The one or more layers may include silicon oxide, silicon dioxide, silicon carbide, and/or a high-k dielectric material.

The high-k dielectric material may include elements such as hafnium, silicon, oxygen, titanium, tantalum, lanthanum, aluminum, zirconium, barium, strontium, yttrium, lead, scandium, niobium, and zinc. Examples of high-k materials that may be used in the gate dielectric include, but are not limited to, hafnium oxide, hafnium silicon oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, lead scandium tantalum oxide, and lead zinc niobate. In some embodiments, an annealing process may be carried out on the gate dielectric to improve its quality when a high-k material is used.

The gate electrode may be formed on the gate dielectric and may include at least one p-type work function metal or n-type work function metal, depending on whether the transistor 740 is to be a p-type metal oxide semiconductor (PMOS) or an n-type metal oxide semiconductor (NMOS) transistor. In some implementations, the gate electrode may consist of a stack of two or more metal layers, where one or more metal layers are work function metal layers and at least one metal layer is a fill metal layer. Further metal layers may be included for other purposes, such as a barrier layer.

For a PMOS transistor, metals that may be used for the gate electrode include, but are not limited to, ruthenium, palladium, platinum, cobalt, nickel, conductive metal oxides (e.g., ruthenium oxide), and any of the metals discussed below with reference to an NMOS transistor (e.g., for work function tuning). For an NMOS transistor, metals that may be used for the gate electrode include, but are not limited to, hafnium, zirconium, titanium, tantalum, aluminum, alloys of these metals, carbides of these metals (e.g., hafnium carbide, zirconium carbide, titanium carbide, tantalum carbide, and aluminum carbide), and any of the metals discussed above with reference to a PMOS transistor (e.g., for work function tuning).

In some embodiments, when viewed as a cross-section of the transistor 740 along the source-channel-drain direction, the gate electrode may consist of a U-shaped structure that includes a bottom portion substantially parallel to the surface of the die substrate 702 and two sidewall portions that are substantially perpendicular to the top surface of the die substrate 702. In other embodiments, at least one of the metal layers that form the gate electrode may simply be a planar layer that is substantially parallel to the top surface of the die substrate 702 and does not include sidewall portions substantially perpendicular to the top surface of the die substrate 702. In other embodiments, the gate electrode may consist of a combination of U-shaped structures and planar, non-U-shaped structures. For example, the gate electrode may consist of one or more U-shaped metal layers formed atop one or more planar, non-U-shaped layers.

In some embodiments, a pair of sidewall spacers may be formed on opposing sides of the gate stack to bracket the gate stack. The sidewall spacers may be formed from materials such as silicon nitride, silicon oxide, silicon carbide, silicon nitride doped with carbon, and silicon oxynitride. Processes for forming sidewall spacers are well known in the art and generally include deposition and etching process steps. In some embodiments, a plurality of spacer pairs may be used; for instance, two pairs, three pairs, or four pairs of sidewall spacers may be formed on opposing sides of the gate stack.

The S/D regions 720 may be formed within the die substrate 702 adjacent to the gate 722 of individual transistors 740. The S/D regions 720 may be formed using an implantation/diffusion process or an etching/deposition process, for example. In the former process, dopants such as boron, aluminum, antimony, phosphorous, or arsenic may be ion-implanted into the die substrate 702 to form the S/D regions 720. An annealing process that activates the dopants and causes them to diffuse farther into the die substrate 702 may follow the ion-implantation process. In the latter process, the die substrate 702 may first be etched to form recesses at the locations of the S/D regions 720. An epitaxial deposition process may then be carried out to fill the recesses with material that is used to fabricate the S/D regions 720. In some implementations, the S/D regions 720 may be fabricated using a silicon alloy such as silicon germanium or silicon carbide. In some embodiments, the epitaxially deposited silicon alloy may be doped in situ with dopants such as boron, arsenic, or phosphorous. In some embodiments, the S/D regions 720 may be formed using one or more alternate semiconductor materials such as germanium or a group III-V material or alloy. In further embodiments, one or more layers of metal and/or metal alloys may be used to form the S/D regions 720.

Electrical signals, such as power and/or input/output (I/O) signals, may be routed to and/or from the devices (e.g., transistors 740) of the device layer 704 through one or more interconnect layers disposed on the device layer 704 (illustrated in FIG. 7 as interconnect layers 706-710). For example, electrically conductive features of the device layer 704 (e.g., the gate 722 and the S/D contacts 724) may be electrically coupled with the interconnect structures 728 of the interconnect layers 706-710. The one or more interconnect layers 706-710 may form a metallization stack (also referred to as an “ILD stack”) 719 of the integrated circuit device 700.

The interconnect structures 728 may be arranged within the interconnect layers 706-710 to route electrical signals according to a wide variety of designs; in particular, the arrangement is not limited to the particular configuration of interconnect structures 728 depicted in FIG. 7. Although a particular number of interconnect layers 706-710 is depicted in FIG. 7, embodiments of the present disclosure include integrated circuit devices having more or fewer interconnect layers than depicted.

In some embodiments, the interconnect structures 728 may include lines 728a and/or vias 728b filled with an electrically conductive material such as a metal. The lines 728a may be arranged to route electrical signals in a direction of a plane that is substantially parallel with a surface of the die substrate 702 upon which the device layer 704 is formed. For example, the lines 728a may route electrical signals in a direction in and out of the page and/or in a direction across the page. The vias 728b may be arranged to route electrical signals in a direction of a plane that is substantially perpendicular to the surface of the die substrate 702 upon which the device layer 704 is formed. In some embodiments, the vias 728b may electrically couple lines 728a of different interconnect layers 706-710 together.

The interconnect layers 706-710 may include a dielectric material 726 disposed between the interconnect structures 728, as shown in FIG. 7. In some embodiments, dielectric material 726 disposed between the interconnect structures 728 in different ones of the interconnect layers 706-710 may have different compositions; in other embodiments, the composition of the dielectric material 726 between different interconnect layers 706-710 may be the same. The device layer 704 may include a dielectric material 726 disposed between the transistors 740 and a bottom layer of the metallization stack as well. The dielectric material 726 included in the device layer 704 may have a different composition than the dielectric material 726 included in the interconnect layers 706-710; in other embodiments, the composition of the dielectric material 726 in the device layer 704 may be the same as a dielectric material 726 included in any one of the interconnect layers 706-710.

A first interconnect layer 706 (referred to as Metal 1 or “M1”) may be formed directly on the device layer 704. In some embodiments, the first interconnect layer 706 may include lines 728a and/or vias 728b, as shown. The lines 728a of the first interconnect layer 706 may be coupled with contacts (e.g., the S/D contacts 724) of the device layer 704. The vias 728b of the first interconnect layer 706 may be coupled with the lines 728a of a second interconnect layer 708.

The second interconnect layer 708 (referred to as Metal 2 or “M2”) may be formed directly on the first interconnect layer 706. In some embodiments, the second interconnect layer 708 may include via 728b to couple the lines 728 of the second interconnect layer 708 with the lines 728a of a third interconnect layer 710. Although the lines 728a and the vias 728b are structurally delineated with a line within individual interconnect layers for the sake of clarity, the lines 728a and the vias 728b may be structurally and/or materially contiguous (e.g., simultaneously filled during a dual-damascene process) in some embodiments.

The third interconnect layer 710 (referred to as Metal 3 or “M3”) (and additional interconnect layers, as desired) may be formed in succession on the second interconnect layer 708 according to similar techniques and configurations described in connection with the second interconnect layer 708 or the first interconnect layer 706. In some embodiments, the interconnect layers that are “higher up” in the metallization stack 719 in the integrated circuit device 700 (i.e., farther away from the device layer 704) may be thicker that the interconnect layers that are lower in the metallization stack 719, with lines 728a and vias 728b in the higher interconnect layers being thicker than those in the lower interconnect layers.

The integrated circuit device 700 may include a solder resist material 734 (e.g., polyimide or similar material) and one or more conductive contacts 736 formed on the interconnect layers 706-710. In FIG. 7, the conductive contacts 736 are illustrated as taking the form of bond pads. The conductive contacts 736 may be electrically coupled with the interconnect structures 728 and configured to route the electrical signals of the transistor(s) 740 to external devices. For example, solder bonds may be formed on the one or more conductive contacts 736 to mechanically and/or electrically couple an integrated circuit die including the integrated circuit device 700 with another component (e.g., a printed circuit board). The integrated circuit device 700 may include additional or alternate structures to route the electrical signals from the interconnect layers 706-710; for example, the conductive contacts 736 may include other analogous features (e.g., posts) that route the electrical signals to external components.

In some embodiments in which the integrated circuit device 700 is a double-sided die, the integrated circuit device 700 may include another metallization stack (not shown) on the opposite side of the device layer(s) 704. This metallization stack may include multiple interconnect layers as discussed above with reference to the interconnect layers 706-710, to provide conductive pathways (e.g., including conductive lines and vias) between the device layer(s) 704 and additional conductive contacts (not shown) on the opposite side of the integrated circuit device 700 from the conductive contacts 736.

In other embodiments in which the integrated circuit device 700 is a double-sided die, the integrated circuit device 700 may include one or more through silicon vias (TSVs) through the die substrate 702; these TSVs may make contact with the device layer(s) 704, and may provide conductive pathways between the device layer(s) 704 and additional conductive contacts (not shown) on the opposite side of the integrated circuit device 700 from the conductive contacts 736. In some embodiments, TSVs extending through the substrate can be used for routing power and ground signals from conductive contacts on the opposite side of the integrated circuit device 700 from the conductive contacts 736 to the transistors 740 and any other components integrated into the die 700, and the metallization stack 719 can be used to route I/O signals from the conductive contacts 736 to transistors 740 and any other components integrated into the die 700.

Multiple integrated circuit devices 700 may be stacked with one or more TSVs in the individual stacked devices providing connection between one of the devices to any of the other devices in the stack. For example, one or more high-bandwidth memory (HBM) integrated circuit dies can be stacked on top of a base integrated circuit die and TSVs in the HBM dies can provide connection between the individual HBM and the base integrated circuit die. Conductive contacts can provide additional connections between adjacent integrated circuit dies in the stack. In some embodiments, the conductive contacts can be fine-pitch solder bumps (microbumps).

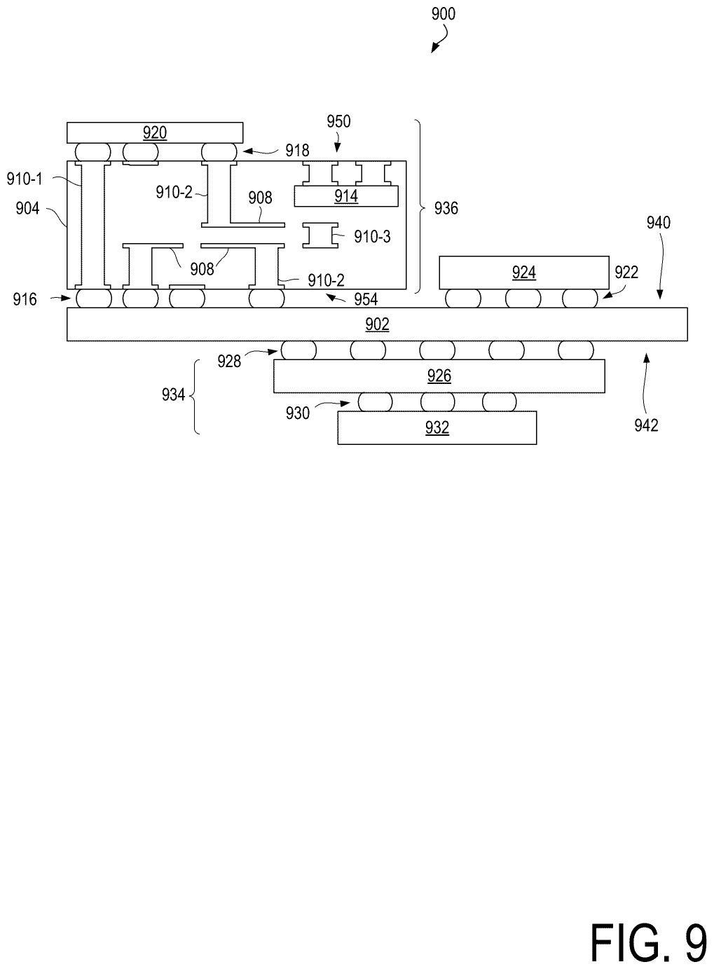

FIG. 9 is a cross-sectional side view of an integrated circuit device assembly 900 that may include any of the integrated circuit packages 100 disclosed herein. In some embodiments, the integrated circuit device assembly 900 may be an integrated circuit packages 100. The integrated circuit device assembly 900 includes a number of components disposed on a circuit board 902 (which may be a motherboard, system board, mainboard, etc.). The integrated circuit device assembly 900 includes components disposed on a first face 940 of the circuit board 902 and an opposing second face 942 of the circuit board 902; generally, components may be disposed on one or both faces 940 and 942. Any of the integrated circuit components discussed below with reference to the integrated circuit device assembly 900 may take the form of any suitable ones of the embodiments of the integrated circuit packages 100 disclosed herein.

In some embodiments, the circuit board 902 may be a printed circuit board (PCB) including multiple metal (or interconnect) layers separated from one another by layers of dielectric material and interconnected by electrically conductive vias. The individual metal layers comprise conductive traces. Any one or more of the metal layers may be formed in a desired circuit pattern to route electrical signals (optionally in conjunction with other metal layers) between the components coupled to the circuit board 902. In other embodiments, the circuit board 902 may be a non-PCB substrate. In some embodiments the circuit board 902 may be, for example, the substrate 102 or substrate 406. The integrated circuit device assembly 900 illustrated in FIG. 9 includes a package-on-interposer structure 936 coupled to the first face 940 of the circuit board 902 by coupling components 916. The coupling components 916 may electrically and mechanically couple the package-on-interposer structure 936 to the circuit board 902, and may include solder balls (as shown in FIG. 9), pins (e.g., as part of a pin grid array (PGA), contacts (e.g., as part of a land grid array (LGA)), male and female portions of a socket, an adhesive, an underfill material, and/or any other suitable electrical and/or mechanical coupling structure.

The package-on-interposer structure 936 may include an integrated circuit component 920 coupled to an interposer 904 by coupling components 918. The coupling components 918 may take any suitable form for the application, such as the forms discussed above with reference to the coupling components 916. Although a single integrated circuit component 920 is shown in FIG. 9, multiple integrated circuit components may be coupled to the interposer 904; indeed, additional interposers may be coupled to the interposer 904. The interposer 904 may provide an intervening substrate used to bridge the circuit board 902 and the integrated circuit component 920.

The integrated circuit component 920 may be a packaged or unpacked integrated circuit product that includes one or more integrated circuit dies (e.g., the die 602 of FIG. 6, the integrated circuit device 700 of FIG. 7) and/or one or more other suitable components. A packaged integrated circuit component comprises one or more integrated circuit dies mounted on a package substrate with the integrated circuit dies and package substrate encapsulated in a casing material, such as a metal, plastic, glass, or ceramic. In one example of an unpackaged integrated circuit component 920, a single monolithic integrated circuit die comprises solder bumps attached to contacts on the die. The solder bumps allow the die to be directly attached to the interposer 904. The integrated circuit component 920 can comprise one or more computing system components, such as one or more processor units (e.g., system-on-a-chip (SoC), processor core, graphics processor unit (GPU), accelerator, chipset processor), I/O controller, memory, or network interface controller. In some embodiments, the integrated circuit component 920 can comprise one or more additional active or passive devices such as capacitors, decoupling capacitors, resistors, inductors, fuses, diodes, transformers, sensors, electrostatic discharge (ESD) devices, and memory devices.

In embodiments where the integrated circuit component 920 comprises multiple integrated circuit dies, they dies can be of the same type (a homogeneous multi-die integrated circuit component) or of two or more different types (a heterogeneous multi-die integrated circuit component). A multi-die integrated circuit component can be referred to as a multi-chip package (MCP) or multi-chip module (MCM).

In addition to comprising one or more processor units, the integrated circuit component 920 can comprise additional components, such as embedded DRAM, stacked high bandwidth memory (HBM), shared cache memories, input/output (I/O) controllers, or memory controllers. Any of these additional components can be located on the same integrated circuit die as a processor unit, or on one or more integrated circuit dies separate from the integrated circuit dies comprising the processor units. These separate integrated circuit dies can be referred to as “chiplets”. In embodiments where an integrated circuit component comprises multiple integrated circuit dies, interconnections between dies can be provided by the package substrate, one or more silicon interposers, one or more silicon bridges embedded in the package substrate (such as Intel® embedded multi-die interconnect bridges (EMIBs)), or combinations thereof.

Generally, the interposer 904 may spread connections to a wider pitch or reroute a connection to a different connection. For example, the interposer 904 may couple the integrated circuit component 920 to a set of ball grid array (BGA) conductive contacts of the coupling components 916 for coupling to the circuit board 902. In the embodiment illustrated in FIG. 9, the integrated circuit component 920 and the circuit board 902 are attached to opposing sides of the interposer 904; in other embodiments, the integrated circuit component 920 and the circuit board 902 may be attached to a same side of the interposer 904. In some embodiments, three or more components may be interconnected by way of the interposer 904.

In some embodiments, the interposer 904 may be formed as a PCB, including multiple metal layers separated from one another by layers of dielectric material and interconnected by electrically conductive vias. In some embodiments, the interposer 904 may be formed of an epoxy resin, a fiberglass-reinforced epoxy resin, an epoxy resin with inorganic fillers, a ceramic material, or a polymer material such as polyimide. In some embodiments, the interposer 904 may be formed of alternate rigid or flexible materials that may include the same materials described above for use in a semiconductor substrate, such as silicon, germanium, and other group III-V and group IV materials. The interposer 904 may include metal interconnects 908 and vias 910, including but not limited to through hole vias 910-1 (that extend from a first face 950 of the interposer 904 to a second face 954 of the interposer 904), blind vias 910-2 (that extend from the first or second faces 950 or 954 of the interposer 904 to an internal metal layer), and buried vias 910-3 (that connect internal metal layers).

In some embodiments, the interposer 904 can comprise a silicon interposer. Through silicon vias (TSV) extending through the silicon interposer can connect connections on a first face of a silicon interposer to an opposing second face of the silicon interposer. In some embodiments, an interposer 904 comprising a silicon interposer can further comprise one or more routing layers to route connections on a first face of the interposer 904 to an opposing second face of the interposer 904.

The interposer 904 may further include embedded devices 914, including both passive and active devices. Such devices may include, but are not limited to, capacitors, decoupling capacitors, resistors, inductors, fuses, diodes, transformers, sensors, electrostatic discharge (ESD) devices, and memory devices. More complex devices such as radio frequency devices, power amplifiers, power management devices, antennas, arrays, sensors, and microelectromechanical systems (MEMS) devices may also be formed on the interposer 904. The package-on-interposer structure 936 may take the form of any of the package-on-interposer structures known in the art.

The integrated circuit device assembly 900 may include an integrated circuit component 924 coupled to the first face 940 of the circuit board 902 by coupling components 922. The coupling components 922 may take the form of any of the embodiments discussed above with reference to the coupling components 916, and the integrated circuit component 924 may take the form of any of the embodiments discussed above with reference to the integrated circuit component 920.

The integrated circuit device assembly 900 illustrated in FIG. 9 includes a package-on-package structure 934 coupled to the second face 942 of the circuit board 902 by coupling components 928. The package-on-package structure 934 may include an integrated circuit component 926 and an integrated circuit component 932 coupled together by coupling components 930 such that the integrated circuit component 926 is disposed between the circuit board 902 and the integrated circuit component 932. The coupling components 928 and 930 may take the form of any of the embodiments of the coupling components 916 discussed above, and the integrated circuit components 926 and 932 may take the form of any of the embodiments of the integrated circuit component 920 discussed above. The package-on-package structure 934 may be configured in accordance with any of the package-on-package structures known in the art.

FIG. 10 is a block diagram of an example electrical device 1000 that may include one or more of the integrated circuit packages 100 disclosed herein. For example, any suitable ones of the components of the electrical device 1000 may include one or more of the integrated circuit device assemblies 900, integrated circuit components 920, integrated circuit devices 700, or integrated circuit dies 602 disclosed herein, and may be arranged in any of the integrated circuit packages 100 disclosed herein. A number of components are illustrated in FIG. 10 as included in the electrical device 1000, but any one or more of these components may be omitted or duplicated, as suitable for the application. In some embodiments, some or all of the components included in the electrical device 1000 may be attached to one or more motherboards mainboards, or system boards. In some embodiments, one or more of these components are fabricated onto a single system-on-a-chip (SoC) die.

Additionally, in various embodiments, the electrical device 1000 may not include one or more of the components illustrated in FIG. 10, but the electrical device 1000 may include interface circuitry for coupling to the one or more components. For example, the electrical device 1000 may not include a display device 1006, but may include display device interface circuitry (e.g., a connector and driver circuitry) to which a display device 1006 may be coupled. In another set of examples, the electrical device 1000 may not include an audio input device 1024 or an audio output device 1008, but may include audio input or output device interface circuitry (e.g., connectors and supporting circuitry) to which an audio input device 1024 or audio output device 1008 may be coupled.

The electrical device 1000 may include one or more processor units 1002 (e.g., one or more processor units). As used herein, the terms “processor unit”, “processing unit” or “processor” may refer to any device or portion of a device that processes electronic data from registers and/or memory to transform that electronic data into other electronic data that may be stored in registers and/or memory. The processor unit 1002 may include one or more digital signal processors (DSPs), application-specific integrated circuits (ASICs), central processing units (CPUs), graphics processing units (GPUs), general-purpose GPUs (GPGPUs), accelerated processing units (APUs), field-programmable gate arrays (FPGAs), neural network processing units (NPUs), data processor units (DPUs), accelerators (e.g., graphics accelerator, compression accelerator, artificial intelligence accelerator), controller cryptoprocessors (specialized processors that execute cryptographic algorithms within hardware), server processors, controllers, or any other suitable type of processor units. As such, the processor unit can be referred to as an XPU (or xPU).

The electrical device 1000 may include a memory 1004, which may itself include one or more memory devices such as volatile memory (e.g., dynamic random access memory (DRAM), static random-access memory (SRAM)), non-volatile memory (e.g., read-only memory (ROM), flash memory, chalcogenide-based phase-change non-voltage memories), solid state memory, and/or a hard drive. In some embodiments, the memory 1004 may include memory that is located on the same integrated circuit die as the processor unit 1002. This memory may be used as cache memory (e.g., Level 1 (L1), Level 2 (L2), Level 3 (L3), Level 4 (L4), Last Level Cache (LLC)) and may include embedded dynamic random access memory (eDRAM) or spin transfer torque magnetic random access memory (STT-MRAM).

In some embodiments, the electrical device 1000 can comprise one or more processor units 1002 that are heterogeneous or asymmetric to another processor unit 1002 in the electrical device 1000. There can be a variety of differences between the processing units 1002 in a system in terms of a spectrum of metrics of merit including architectural, microarchitectural, thermal, power consumption characteristics, and the like. These differences can effectively manifest themselves as asymmetry and heterogeneity among the processor units 1002 in the electrical device 1000.

In some embodiments, the electrical device 1000 may include a communication component 1012 (e.g., one or more communication components). For example, the communication component 1012 can manage wireless communications for the transfer of data to and from the electrical device 1000. The term “wireless” and its derivatives may be used to describe circuits, devices, systems, methods, techniques, communications channels, etc., that may communicate data through the use of modulated electromagnetic radiation through a nonsolid medium. The term “wireless” does not imply that the associated devices do not contain any wires, although in some embodiments they might not.

The communication component 1012 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication component 1012 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication component 1012 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication component 1012 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication component 1012 may operate in accordance with other wireless protocols in other embodiments. The electrical device 1000 may include an antenna 1022 to facilitate wireless communications and/or to receive other wireless communications (such as AM or FM radio transmissions).

In some embodiments, the communication component 1012 may manage wired communications, such as electrical, optical, or any other suitable communication protocols (e.g., IEEE 802.3 Ethernet standards). As noted above, the communication component 1012 may include multiple communication components. For instance, a first communication component 1012 may be dedicated to shorter-range wireless communications such as Wi-Fi or Bluetooth, and a second communication component 1012 may be dedicated to longer-range wireless communications such as global positioning system (GPS), EDGE, GPRS, CDMA, WiMAX, LTE, EV-DO, or others. In some embodiments, a first communication component 1012 may be dedicated to wireless communications, and a second communication component 1012 may be dedicated to wired communications.

The electrical device 1000 may include battery/power circuitry 1014. The battery/power circuitry 1014 may include one or more energy storage devices (e.g., batteries or capacitors) and/or circuitry for coupling components of the electrical device 1000 to an energy source separate from the electrical device 1000 (e.g., AC line power).

The electrical device 1000 may include a display device 1006 (or corresponding interface circuitry, as discussed above). The display device 1006 may include one or more embedded or wired or wirelessly connected external visual indicators, such as a heads-up display, a computer monitor, a projector, a touchscreen display, a liquid crystal display (LCD), a light-emitting diode display, or a flat panel display.

The electrical device 1000 may include an audio output device 1008 (or corresponding interface circuitry, as discussed above). The audio output device 1008 may include any embedded or wired or wirelessly connected external device that generates an audible indicator, such as speakers, headsets, or earbuds.

The electrical device 1000 may include an audio input device 1024 (or corresponding interface circuitry, as discussed above). The audio input device 1024 may include any embedded or wired or wirelessly connected device that generates a signal representative of a sound, such as microphones, microphone arrays, or digital instruments (e.g., instruments having a musical instrument digital interface (MIDI) output). The electrical device 1000 may include a Global Navigation Satellite System (GNSS) device 1018 (or corresponding interface circuitry, as discussed above), such as a Global Positioning System (GPS) device. The GNSS device 1018 may be in communication with a satellite-based system and may determine a geolocation of the electrical device 1000 based on information received from one or more GNSS satellites, as known in the art.

The electrical device 1000 may include an other output device 1010 (or corresponding interface circuitry, as discussed above). Examples of the other output device 1010 may include an audio codec, a video codec, a printer, a wired or wireless transmitter for providing information to other devices, or an additional storage device.

The electrical device 1000 may include an other input device 1020 (or corresponding interface circuitry, as discussed above). Examples of the other input device 1020 may include an accelerometer, a gyroscope, a compass, an image capture device (e.g., monoscopic or stereoscopic camera), a trackball, a trackpad, a touchpad, a keyboard, a cursor control device such as a mouse, a stylus, a touchscreen, proximity sensor, microphone, a bar code reader, a Quick Response (QR) code reader, electrocardiogram (ECG) sensor, PPG (photoplethysmogram) sensor, galvanic skin response sensor, any other sensor, or a radio frequency identification (RFID) reader.

The electrical device 1000 may have any desired form factor, such as a hand-held or mobile electrical device (e.g., a cell phone, a smart phone, a mobile internet device, a music player, a tablet computer, a laptop computer, a 2-in-1 convertible computer, a portable all-in-one computer, a netbook computer, an ultrabook computer, a personal digital assistant (PDA), an ultra mobile personal computer, a portable gaming console, etc.), a desktop electrical device, a server, a rack-level computing solution (e.g., blade, tray or sled computing systems), a workstation or other networked computing component, a printer, a scanner, a monitor, a set-top box, an entertainment control unit, a stationary gaming console, smart television, a vehicle control unit, a digital camera, a digital video recorder, a wearable electrical device or an embedded computing system (e.g., computing systems that are part of a vehicle, smart home appliance, consumer electronics product or equipment, manufacturing equipment). In some embodiments, the electrical device 1000 may be any other electronic device that processes data. In some embodiments, the electrical device 1000 may comprise multiple discrete physical components. Given the range of devices that the electrical device 1000 can be manifested as in various embodiments, in some embodiments, the electrical device 1000 can be referred to as a computing device or a computing system.

### Examples

Illustrative examples of the technologies disclosed herein are provided below. An embodiment of the technologies may include any one or more, and any combination of, the examples described below.

Example 1 includes an apparatus comprising a substrate comprising a top surface, a bottom surface, and one or more edges; and an optical interposer mounted on the substrate, wherein a cavity is defined in the substrate, wherein the cavity extends from the top surface to the bottom surface, wherein the cavity extends to one of the one or more edges, wherein the cavity defines one or more alignment features to align an optical cable to the optical interposer, wherein the optical interposer extends at least partially over the cavity.

Example 2 includes the subject matter of Example 1, and wherein the one or more alignment features comprise one or more straight edges of the cavity.

Example 3 includes the subject matter of any of Examples 1 and 2, and wherein one or more indents are defined in the substrate as part of the cavity, further comprising an optical plug mated with the optical interposer, wherein the optical plug comprises one or more protrusions mated with the one or more indents.

Example 4 includes the subject matter of any of Examples 1-3, and wherein the optical plug comprises a pull tab, wherein, when a pulling force is applied to the pull tab, the pull tab releases the one or more protrusions from the one or more indents.

Example 5 includes the subject matter of any of Examples 1-4, and wherein the optical plug comprises a ferrule; and one or more optical fibers mated with the ferrule, wherein the ferrule is pressed against the optical interposer.

Example 6 includes the subject matter of any of Examples 1-5, and wherein the one or more optical fibers comprise at least eight optical fibers.

Example 7 includes the subject matter of any of Examples 1-6, and wherein one or more waveguides are defined in the optical interposer, wherein the one or more optical fibers are aligned to the one or more waveguides.

Example 8 includes the subject matter of any of Examples 1-7, and further including one or more photonic integrated circuit (PIC) dies coupled to the optical interposer, wherein the one or more waveguides of the optical interposer are to carry light between the optical cable and the one or more PIC dies.

Example 9 includes the subject matter of any of Examples 1-8, and further including one or more electronic integrated circuit (EIC) dies, wherein the one or more EIC dies are electrically coupled to the one or more PIC dies.

Example 10 includes the subject matter of any of Examples 1-9, and wherein a shelf is defined in the substrate, wherein the shelf is recessed from the top surface, wherein the optical interposer is disposed on the shelf.

Example 11 includes the subject matter of any of Examples 1-10, and wherein the shelf is recessed by 50-250 micrometers.

Example 12 includes the subject matter of any of Examples 1-11, and further including a lid disposed above the substrate, wherein the lid comprises a rib orientation key.

Example 13 includes an apparatus comprising a substrate comprising a top surface and a bottom surface, wherein a cavity is defined in the substrate, the cavity extending from the bottom surface to the top surface, wherein a shelf is defined in the substrate, wherein the shelf is recessed from the top surface; and an optical interposer, wherein the optical interposer is mounted on the shelf, wherein the optical interposer extends at least partially over the cavity.

Example 14 includes the subject matter of Example 13, and wherein the shelf is recessed by 50-250 micrometers.

Example 15 includes the subject matter of any of Examples 13 and 14, and wherein one or more indents are defined in the substrate as part of the cavity, further comprising an optical plug mated with the optical interposer, wherein the optical plug comprises one or more protrusions mated with the one or more indents.

Example 16 includes the subject matter of any of Examples 13-15, and wherein the optical plug comprises a pull tab, wherein, when a pulling force is applied to the pull tab, the pull tab releases the one or more protrusions from the one or more indents.

Example 17 includes the subject matter of any of Examples 13-16, and wherein the optical plug comprises a ferrule; and one or more optical fibers mated with the ferrule, wherein the ferrule is pressed against the optical interposer.

Example 18 includes the subject matter of any of Examples 13-17, and wherein the one or more optical fibers comprise at least eight optical fibers.

Example 19 includes the subject matter of any of Examples 13-18, and wherein one or more waveguides are defined in the optical interposer, wherein the one or more optical fibers are aligned to the one or more waveguides.

Example 20 includes the subject matter of any of Examples 13-19, and further including one or more photonic integrated circuit (PIC) dies coupled to the optical interposer, wherein the one or more waveguides of the optical interposer are to carry light between the optical plug and the one or more PIC dies.

Example 21 includes the subject matter of any of Examples 13-20, and further including one or more electronic integrated circuit (EIC) dies, wherein the one or more EIC dies are electrically coupled to the one or more PIC dies.

Example 22 includes the subject matter of any of Examples 13-21, and further including a lid disposed above the substrate, wherein the lid comprises a rib orientation key.

Example 23 includes an apparatus comprising a substrate comprising a top surface, a bottom surface, and one or more edges; and an optical interposer mounted on the substrate, wherein a cavity is defined in the substrate, wherein the cavity extends from the top surface to the bottom surface, wherein the cavity comprises means for aligning an optical plug to the optical interposer.

Example 24 includes the subject matter of Example 23, and wherein the means for aligning the optical plug comprise one or more straight edges of the cavity.

Example 25 includes the subject matter of any of Examples 23 and 24, and wherein one or more indents are defined in the substrate as part of the cavity, further comprising the optical plug mated with the optical interposer, wherein the optical plug comprises one or more protrusions mated with the one or more indents.

Example 26 includes the subject matter of any of Examples 23-25, and wherein the optical plug comprises a pull tab, wherein, when a pulling force is applied to the pull tab, the pull tab releases the one or more protrusions from the one or more indents.

Example 27 includes the subject matter of any of Examples 23-26, and wherein the optical plug comprises a ferrule; and one or more optical fibers mated with the ferrule, wherein the ferrule is pressed against the optical interposer.

Example 28 includes the subject matter of any of Examples 23-27, and wherein the one or more optical fibers comprise at least eight optical fibers.

Example 29 includes the subject matter of any of Examples 23-28, and wherein one or more waveguides are defined in the optical interposer, wherein the one or more optical fibers are aligned to the one or more waveguides.

Example 30 includes the subject matter of any of Examples 23-29, and further including one or more photonic integrated circuit (PIC) dies coupled to the optical interposer, wherein the one or more waveguides of the optical interposer are to carry light between the optical plug and the one or more PIC dies.

Example 31 includes the subject matter of any of Examples 23-30, and further including one or more electronic integrated circuit (EIC) dies, wherein the one or more EIC dies are electrically coupled to the one or more PIC dies.

Example 32 includes the subject matter of any of Examples 23-31, and wherein a shelf is defined in the substrate, wherein the shelf is recessed from the top surface, wherein the optical interposer is disposed on the shelf.

Example 33 includes the subject matter of any of Examples 23-32, and wherein the shelf is recessed by 50-250 micrometers.

Example 34 includes the subject matter of any of Examples 23-33, and further including a lid disposed above the substrate, wherein the lid comprises a rib orientation key.

1. An apparatus comprising:
a substrate comprising a top surface, a bottom surface, and one or more edges; and
an optical interposer mounted on the substrate,
wherein a cavity is defined in the substrate, wherein the cavity extends from the top surface to the bottom surface, wherein the cavity extends to one of the one or more edges,
wherein the cavity defines one or more alignment features to align an optical cable to the optical interposer,
wherein the optical interposer extends at least partially over the cavity.

2. The apparatus of claim 1, wherein the one or more alignment features comprise one or more straight edges of the cavity.

3. The apparatus of claim 1, wherein one or more indents are defined in the substrate as part of the cavity, further comprising an optical plug mated with the optical interposer, wherein the optical plug comprises one or more protrusions mated with the one or more indents.

4. The optical cable of claim 3, wherein the optical plug comprises a pull tab, wherein, when a pulling force is applied to the pull tab, the pull tab releases the one or more protrusions from the one or more indents.

5. The optical cable of claim 3, wherein the optical plug comprises:
a ferrule; and
one or more optical fibers mated with the ferrule,
wherein the ferrule is pressed against the optical interposer.

6. The apparatus of claim 5, wherein the one or more optical fibers comprise at least eight optical fibers.

7. The apparatus of claim 5, wherein one or more waveguides are defined in the optical interposer,
wherein the one or more optical fibers are aligned to the one or more waveguides.

8. The apparatus of claim 7, further comprising one or more photonic integrated circuit (PIC) dies coupled to the optical interposer,
wherein the one or more waveguides of the optical interposer are to carry light between the optical cable and the one or more PIC dies.

9. The apparatus of claim 8, further comprising one or more electronic integrated circuit (EIC) dies, wherein the one or more EIC dies are electrically coupled to the one or more PIC dies.

10. The apparatus of claim 1, wherein a shelf is defined in the substrate, wherein the shelf is recessed from the top surface, wherein the optical interposer is disposed on the shelf.

11. The apparatus of claim 10, wherein the shelf is recessed by 50-250 micrometers.

12. The apparatus of claim 1, further comprising a lid disposed above the substrate, wherein the lid comprises a rib orientation key.

13. An apparatus comprising:
a substrate comprising a top surface and a bottom surface, wherein a cavity is defined in the substrate, the cavity extending from the bottom surface to the top surface, wherein a shelf is defined in the substrate, wherein the shelf is recessed from the top surface; and
an optical interposer, wherein the optical interposer is mounted on the shelf, wherein the optical interposer extends at least partially over the cavity.

14. The apparatus of claim 13, wherein the shelf is recessed by 50-250 micrometers.

15. The apparatus of claim 13, wherein one or more indents are defined in the substrate as part of the cavity, further comprising an optical plug mated with the optical interposer, wherein the optical plug comprises one or more protrusions mated with the one or more indents.

16. The apparatus of claim 15, wherein the optical plug comprises:
a ferrule; and
one or more optical fibers mated with the ferrule,
wherein the ferrule is pressed against the optical interposer.

17. The apparatus of claim 13, further comprising a lid disposed above the substrate, wherein the lid comprises a rib orientation key.

18. An apparatus comprising:
a substrate comprising a top surface, a bottom surface, and one or more edges; and
an optical interposer mounted on the substrate,
wherein a cavity is defined in the substrate, wherein the cavity extends from the top surface to the bottom surface, wherein the cavity comprises means for aligning an optical plug to the optical interposer.

19. The apparatus of claim 18, wherein the means for aligning the optical plug comprise one or more straight edges of the cavity.

20. The apparatus of claim 18, wherein a shelf is defined in the substrate, wherein the shelf is recessed from the top surface, wherein the optical interposer is disposed on the shelf.
